(19) United States
(12) Patent Application Publication
(10) Pub. No.: US 2024/0025274 A1
(43) Pub. Date: Jan. 25, 2024

(54) ENERGY STORAGE PRESSURE VESSEL FOR A HYDROGEN VEHICLE

(71) Applicant: VOLVO TRUCK CORPORATION, Göteborg (SE)

(72) Inventor: Andreas MATTIASSON, Mölndal (SE)

(73) Assignee: VOLVO TRUCK CORPORATION, Göteborg (SE)

(21) Appl. No.: 18/253,367

(22) PCT Filed: Nov. 24, 2020
(86) PCT No.: PCT/EP2020/083228

§ 371 Date: May 17, 2023

(51) Int. Cl. B60L 50/75; B62D 33/06; B60K 15/063; H01M 8/04082; H01M 8/04089; H01M 16/00; H01M 4/583; F17C 1/00

(52) U.S. Cl. CPC B60L 50/75; B62D 33/06; B60K 15/063; H01M 8/04216; H01M 8/04089; H01M 16/003; H01M 4/583; F17C 1/00; B60K 2015/03315

(57) ABSTRACT

There is provided an energy storage pressure vessel for a hydrogen vehicle. The energy storage pressure vessel comprises a pressure vessel for containing hydrogen gas for fuel cells of the hydrogen vehicle. The pressure vessel is radially surrounded by a membrane. The energy storage pressure vessel comprises an energy storage system. The energy storage system is provided in the membrane.

### TECHNICAL FIELD

Embodiments presented herein relate to an energy storage pressure vessel for a hydrogen vehicle. Embodiments presented herein further relate to a hydrogen vehicle comprising such an energy storage pressure vessel.

### BACKGROUND

A hydrogen vehicle is a vehicle that uses hydrogen fuel for motive power. Hydrogen vehicles include hydrogen-fueled space rockets, as well as automobiles and other transportation vehicles. The power plants of such vehicles convert the chemical energy of hydrogen to mechanical energy either by burning hydrogen in an internal combustion engine, or, more commonly, by reacting hydrogen with oxygen in a fuel cell to power electric motors.

A hydrogen internal combustion engine vehicle (HICEV) is a type of hydrogen vehicle using an internal combustion engine. Hydrogen internal combustion engine vehicles are different from hydrogen fuel cell vehicles (which use electrochemical use of hydrogen rather than combustion). Instead, the hydrogen internal combustion engine is simply a modified version of the traditional gasoline-powered internal combustion engine.

A fuel cell electric vehicle (FCEV) is an electric vehicle that uses fuel cells, sometimes in combination with a battery or supercapacitor, to power its onboard electric traction motor. Fuel cells in the FCEV generate electricity generally using oxygen from the air and compressed hydrogen. FCEVs might thus be considered as powered by hydrogen. FCEVs are generally regarded as being more efficient than conventional internal combustion engine vehicles. Unlike conventional internal combustion engine vehicles, FCEVs emit only water vapor and warm air and hence do not produce any harmful tailpipe emissions. FCEVs use a propulsion system similar to that of electric vehicles, where energy stored as hydrogen is converted to electricity by the fuel cells. FCEVs are fuelled with pure hydrogen gas stored in a tank on the vehicle.

Like all-electric vehicles, FCEVs use electricity to power an electric traction motor for driving the FCEV. In contrast to other electric vehicles, FCEVs produce electricity using a fuel cell powered by hydrogen, rather than drawing electricity from only a battery. Energy generated from regenerative braking might be stored in an energy storage system (ESS), such as a battery. The ESS provides supplemental power to the electric traction motor. FCEVs might thus be equipped with other advanced technologies to increase efficiency, such as regenerative braking systems, which capture the energy lost during braking and store it in a battery.

One common type of fuel cell for vehicle applications is the proton-exchange membrane fuel cell (PEMFC), also known as a polymer electrolyte membrane (PEM) fuel cell. In a PEM fuel cell, an electrolyte membrane is sandwiched between a positive electrode (cathode) and a negative electrode (anode). Hydrogen is introduced, from a hydrogen fuel storage tank, to the anode, and oxygen (from air) is introduced to the cathode. The hydrogen molecules break apart into protons and electrons due to an electrochemical reaction in the fuel cell catalyst. Protons then travel through the membrane to the cathode. The electrons are forced to travel through an external circuit to perform work (providing power to the electric car) then recombine with the protons on the cathode side, where the protons, electrons, and oxygen molecules combine to form water. An assembly of individual fuel cells are commonly arranged in a fuel cell stack.

FCEVs might utilize generally cylindrical fuel storage tanks for storing the hydrogen. The cylindrical geometry of such tanks is generally dictated by the relatively high pressures necessary to store an adequate amount of hydrogen. Needless to say, cylindrical fuel storage tanks do not package well in automotive vehicles, notwithstanding that engineers have striven for years to achieve acceptable packaging of the cylindrical fuel storage tanks coupled with acceptable vehicle range.

The need for packaging an electrical storage battery within either a hybrid electric vehicle or a fuel cell vehicle further compounds the problems faced by vehicle designers. Such batteries are typically not package-efficient and in fact, have frequently been of either a flat construction or square sectional construction, neither of which is particularly conducive to packaging within the confines of an automotive vehicle.

United States patent application publication US 2004/0173391 A1 discloses an energy producing and storage system for a vehicle. The energy producing and storage system includes a compressed gas storage tank having a generally cylindrical outer wall and a generally cylindrical battery having a partially triangular section defined in part by a concave surface extending along and nested with at least a portion of the cylindrical outer wall of the gas storage tank. The energy producing and storage system also includes a fuel cell disposed in a concavity formed in the vehicle body, thereby further minimizing the passenger and/or trunk space required to accommodate the system.

However there is still a need for yet further minimizing the passenger and/or trunk space required to accommodate the energy producing and storage system for a hydrogen vehicle.

### SUMMARY

An object of embodiments herein is to provide an energy storage pressure vessel for a hydrogen vehicle addressing the above issues.

According to a first aspect there is presented an energy storage pressure vessel for a hydrogen vehicle. The energy storage pressure vessel comprises a pressure vessel for containing hydrogen gas for fuel cells of the hydrogen vehicle. The pressure vessel is radially surrounded by a membrane. The energy storage pressure vessel comprises an energy storage system. The energy storage system is provided in the membrane.

According to second aspect there is provided a hydrogen vehicle comprising such an energy storage pressure vessel.

Advantageously, the provided energy storage pressure vessel makes efficient use of the already existing pressure vessel for containing hydrogen gas.

Advantageously, the provided energy storage pressure vessel has a low packaging volume. For example, the provided energy storage pressure vessel has a lower packaging volume than the energy producing and storage system in aforementioned document US 2004/0173391 A1.

Advantageously, the provided energy storage pressure vessel has a low weight. For example, by incorporating the energy storage system in the membrane of the pressure vessel, there is no need to have a separate energy storage system.

In some embodiments the hydrogen vehicle further comprises an electric traction motor, and the at least one energy storage system is configured to provide the electric traction motor with electricity for driving the hydrogen vehicle. Advantageously, this removes the need for the hydrogen vehicle to be equipped with a conventional traction battery for powering the electric traction motor, or at least reduces the size requirements and energy storage requirements for such a conventional traction battery.

In some embodiments the hydrogen vehicle further comprises a cabin for housing a human driver of the hydrogen vehicle, the cabin comprising electronic components, and the at least one energy storage system being configured to provide the electronic components with electricity. Advantageously, this removes the need for the hydrogen vehicle to be equipped with a conventional battery for powering these electronic components, or at least reduces the size requirements and energy storage requirements for such a conventional battery.

Further advantages and advantageous features of the herein disclosed embodiments are disclosed in the following description and in the dependent claims.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating an energy storage pressure vessel according to an embodiment;

FIGS. 2 and 3 are schematic diagrams illustrating energy storage systems according to embodiments; and

FIG. 4 is a schematic diagram illustrating a hydrogen vehicle according to an embodiment.

### DETAILED DESCRIPTION OF EXAMPLE EMBODIMENTS

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

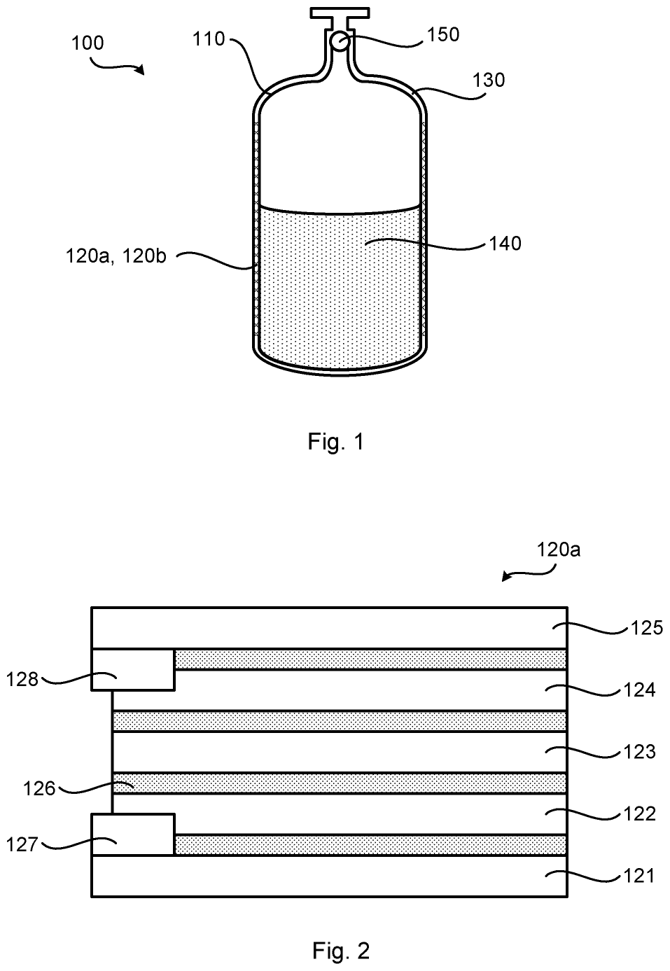

Reference is now made to FIG. 1. FIG. 1 schematically illustrates an energy storage pressure vessel 100 for a hydrogen vehicle according to an embodiment.

The energy storage pressure vessel 100 comprises a pressure vessel 110. The pressure vessel 110 is arranged for containing hydrogen gas 140 for fuel cells of the hydrogen vehicle. It is here noted that, to be precise, reference numeral 110 in FIG. 1 points to the interior of the pressure vessel, whereas the pressure vessel itself is defined by the walls enclosing the interior. The pressure vessel 110 is radially surrounded by a membrane 130. In some aspects, the membrane 130 defines an outer perimeter of the pressure vessel 110. The energy storage pressure vessel 100 further comprises an energy storage system 120a, 120b. The energy storage system 120a, 120b is provided in the membrane 130.

Hydrogen gas 140 is allowed to enter the pressure vessel 110 and to be released from the pressure vessel 110 by means of a valve assembly 150. In this respect, the valve assembly 150 might be a stop angle valve. During storage, transportation, and handling when the hydrogen gas 140 is not in use, a cap may be screwed over the valve assembly 150 to protect it from damage or breaking off in case the pressure vessel 110 were to fall over. Instead of a cap, pressure vessel 110 commonly have a protective collar or neck ring around the valve assembly 150. When the hydrogen gas 140 in the pressure vessel 110 is to be used at low pressure, the cap is taken off and a pressure-regulating assembly is attached to the valve assembly 150. This attachment typically has a pressure regulator with upstream (inlet) and downstream (outlet) pressure gauges and a further downstream needle valve and outlet connection. The fuel cells of the hydrogen vehicle can then be connected to the pressure vessel 110 via this attachment.

Further aspects of the energy storage system 120a, 120b will now be disclosed.

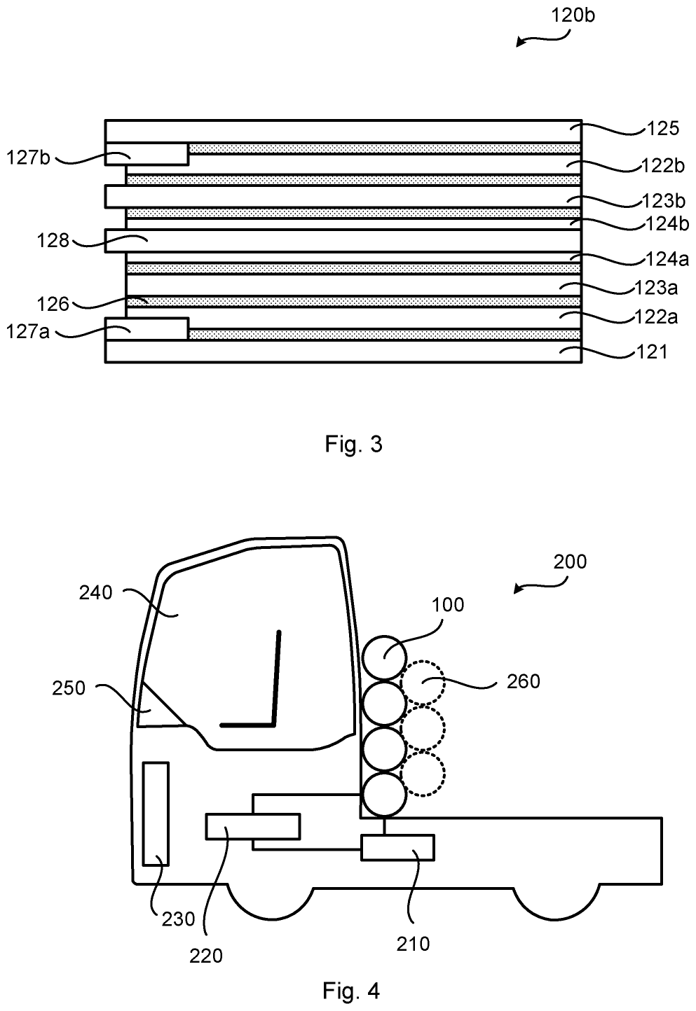

There could be different types of energy storage system 120a, 120b. In some embodiments, the energy storage system 120a, 120b is a structural battery. Two examples of energy storage systems 120a, 120b in the form of structural batteries are illustrated in FIG. 2 and FIG. 3.

Reference is now made to FIG. 2. FIG. 2 is a schematic diagram illustrating an energy storage system 120a in the form of a structural battery according to an embodiment. FIG. 2 illustrates an example where the structural battery is composed of a single battery cell. The energy storage system 120a comprises layers 121, 122, 123, 124, 125. All layers 121:125 are provided in the membrane. The layers 121:125 might in the membrane be provided in a structural electrolyte matrix 126. Current collectors 127, 128 are connected to two of the layers 122, 124. The energy storage system 120a could be connected to an electric traction motor in the hydrogen vehicle via the current collectors 127, 128. Aspects of each layer 121:125 will now be disclosed. Layer 121 is a liner. One example of a liner is a polymer liner. Layer 121 might border the pressure vessel 110. Layer 122 is a negative electrode. One example of a negative electrode is a first carbon fibre electrode. The negative electrode is connected to current collector 127. Layer 123 is a separator. One example of a separator is a glass fibre separator. Layer 124 is a positive electrode. One example of a positive electrode is as a second carbon fibre electrode. The positive electrode is connected to current collector 128. Layer 125 is a protective layer. One example of a protective layer is a polymer protective layer. Layer 125 might border, or define, the outer perimeter of the membrane 130.

Reference is now made to FIG. 3. FIG. 3 is a schematic diagram illustrating an energy storage system 120b in the form of a structural battery according to an embodiment. FIG. 3 illustrates an example where the structural battery is composed of composed of at least two serially connected or parallel connected battery cells. The energy storage system 120b comprises layers 121, 122a, 122b, 123a, 123b, 124a, 124b, 125. All layers 121:125 are provided in the membrane. The layers 121:125 might in the membrane be provided in a structural electrolyte matrix 126. Current collectors 127a, 127b, 128 are connected to four of the layers 122a, 122b, 124a, 124b. The energy storage system 120b could be connected to an electric traction motor in the hydrogen vehicle via the current collectors 127a, 127b, 128. Aspects of each layer 121:125 will now be disclosed. Layer 121 is a liner. One example of a liner is a polymer liner. Layer 121 might border the pressure vessel 110. Layer 122a is a first negative electrode. One example of a first negative electrode is a first carbon fibre electrode. The first negative electrode is connected to current collector 127a. Layer 123a is a first separator. One example of a first separator is a first glass fibre separator. Layer 124a is a first positive electrode. One example of a first positive electrode is as a second carbon fibre electrode. The first positive electrode is connected to current collector 128. Layer 124b is a second positive electrode. One example of a second positive electrode is as a third carbon fibre electrode. The second positive electrode is connected to current collector 128. Layer 123b is a second separator. One example of a second separator is a second glass fibre separator. Layer 122b is a second negative electrode. One example of a second negative electrode is a fourth carbon fibre electrode. The second negative electrode is connected to current collector 127b. Layer 125 is a protective layer. One example of a protective layer is a polymer protective layer. Layer 125 might border, or define, the outer perimeter of the membrane 130.

Different examples of publications disclosing structural batteries which might be used in accordance with the herein disclosed embodiments will now be provided.

In “Structural battery composites: a review” by Asp, Leif, E. et al in Funct. Compos. Struct., Vol. 1, Issue 4, 2019, published by The Korean Society for Composite Materials and IOP Publishing Limited on 21 Nov. 2019, is provided a comprehensive review of the state-of-the-art in structural battery composites research. One example of a structural battery design discussed therein and which could be used in accordance with the herein disclosed embodiments is a structural battery having a laminated structure (referred therein to as a laminated structural battery and laiminated battery cell) where two electrode layers are separated by an electrically insulating (separator) layer. Another example of a structural battery design discussed therein and which could be used in accordance with the herein disclosed embodiments is a 3D-fibre structural battery.

In “Prospective Life Cycle Assessment of a Structural Battery” by Zackrisson, M. et al. in Sustainability 2019, Vol. 11, Issue 20, published on 14 Oct. 2019, is proposed a structural battery that is incorporated in the roof of an electric vehicle. The structural battery has a laminated structure and can be composed of several battery cells.

In “Impact of Cell Size and Format on External Short Circuit Behavior of Lithium-Ion Cells at Varying Cooling Conditions: Modeling and Simulation” by Rheinfeld, A. et al., published in Journal of The Electrochemical Society on 3 Oct. 2019 is presented a multidimensional multiphysics model to describe the external short circuit behavior of lithium-ion cells of various formats and sizes at different convective cooling conditions. The structural battery has a laminated structure and can be composed of several battery cells.

In “Structural Composite Lithium-ion Battery—Effect of intercalation induced volumetric changes on micro-damage” by Xu, J, Doctoral Thesis, Luleå University of Technology, Department of Engineering Sciences and Mathematics, Division of Materials Science, published on 7 Feb. 2019, is provided examples of 3D-fibre structural batteries having parallel connected battery cells.

Further aspects of the energy storage systems 120a, 120b will now be disclosed with continued reference to FIG. 2 and FIG. 3.

As in the examples of FIG. 2 and FIG. 3 the structural battery membrane 130 might comprise carbon fibre electrodes that act both as electrodes and as the main structural element of the membrane 130. That is, in some embodiments, the structural battery comprises carbon fibre electrodes 122, 122a, 122b, 124, 124a, 124b that act both as electrodes and as main structural element of the membrane 130.

As in the examples of FIG. 2 and FIG. 3 the membrane 130 might comprise alternating layers of negative electrodes, separators, and positive electrodes. That is, in some embodiments, the membrane 130 comprises alternating layers of negative electrodes 122, 122a, 122b, separators 123, 123a, 123b, and positive electrodes 124, 124a, 124b. Further, in some embodiments, a structural battery electrolyte (SBE) is dispersed throughout the alternating layers.

In some embodiments, the pressure vessel 110 is cylindrically shaped. The membrane 130 might then be composed of concentric layers of carbon fibre electrodes that are wrapped around the pressure vessel 110. That is, in some embodiments, the membrane 130 is formed by concentric layers of carbon fibre electrodes 122, 122a, 122b, 124, 124a, 124b that are wrapped around the pressure vessel 110.

In some aspects, the energy storage pressure vessel 100 is part of a vehicle, such as a hydrogen vehicle. Hence, in some aspects, there is provided a hydrogen vehicle, where the hydrogen vehicle comprises at least one energy storage pressure vessel 100 as herein disclosed.

Reference is now made to FIG. 4. FIG. 4 schematically illustrates a hydrogen vehicle 200 according to an embodiment. The hydrogen vehicle 200 might be an HICEV or an FCEV. In FIG. 4 is illustrated a hydrogen vehicle 200 in terms of a FCEV. The hydrogen vehicle 200 comprises at least one energy storage pressure vessel 100, an electric traction motor 210, a fuel cell stack 220, a cooling radiator 230, a cabin 240 comprising electronic components 250, and an optional further pressure vessel 260. Each of these entities will now be described in turn. As the skilled person understands, the hydrogen vehicle 200 comprises further components than those illustrated in FIG. 4. For example, if the hydrogen vehicle 200 is an HICEV, the electric traction motor 210 is replaced with an internal combustion engine (ICE). For an HICEV the hydrogen is provided to the ICE instead of the fuel cells.

In general terms, the electric traction motor 210 uses power delivered from the fuel cell stack 220 and the energy storage system 120a, 120b of the energy storage pressure vessel 100 to drive the wheels of the hydrogen vehicle 200. Some hydrogen vehicles 200 use motor generators that perform both the drive and regeneration functions. In some embodiments, the at least one energy storage system 120a, 120b is configured to provide the electric traction motor 210 with electricity for driving the hydrogen vehicle 200. The electric traction motor 210 could therefore be connected to the current collectors 127, 127a, 127b, 128 of the energy storage system 120a, 120b.

In general terms, the fuel cell stack 220 is an assembly composed of individual membrane electrodes that use hydrogen and oxygen to produce electricity to be provided to the electric traction motor 210.

In general terms, the cooling radiator 230 forms part of a cooling system and is configured to provide cooling to components of the hydrogen vehicle 200, such as the electric traction motor 210 and/or the fuel cell stack 220.

In general terms, the cabin 240 is arranged to house a human driver of the hydrogen vehicle and for example comprises one or more electronic components 250. In some embodiments, the at least one energy storage system 120a, 120b is configured to provide the electronic components 250 with electricity. The electronic components 250 might be provided on the dashboard of the cabin 240 and/or other places of the cabin 250. The electronic components 250 might be part of lights, displays, radio equipment, fans, security systems, etc.

There could be different ways in which the at least one energy storage pressure vessel 100 is arranged in the hydrogen vehicle 200. In some aspects, the at least one energy storage pressure vessels 100 is located behind the cabin 240. That is, in some embodiments, the at least one energy storage system 120a, 120b is in the hydrogen vehicle 200 placed behind the cabin 240. In some aspects, two or more energy storage pressure vessels 100 are vertically stacked. That is, in some embodiments, the hydrogen vehicle 200 comprises at least two energy storage pressure vessels 100, and the at least two energy storage pressure vessels 100 are vertically stacked in the hydrogen vehicle 200. In the illustrative example of FIG. 4, the hydrogen vehicle 200 comprises four such vertically stacked energy storage pressure vessels 100. However, also other placements of two or more energy storage pressure vessels 100 are envisioned within the scope of the herein disclosed embodiments.

The hydrogen vehicle 200 might comprise one or more conventional hydrogen tanks. In this respect, as disclosed above, the hydrogen vehicle 200 of the illustrative example of FIG. 4 comprises at least one further pressure vessel 260. Particularly, in some embodiments, the hydrogen vehicle 200 further comprises at least one further pressure vessel 260 for containing hydrogen gas 140 for the fuel cells 220 of the hydrogen vehicle 200. Each such at least one further pressure vessel 260 is radially surrounded by a membrane being without any energy storage system. In the illustrative example of FIG. 4, the hydrogen vehicle 200 comprises three such vertically stacked further energy storage pressure vessels 260.

There could be different examples of hydrogen vehicles 200. The hydrogen vehicle 200 illustrated in FIG. 4 is a truck. However, the hydrogen vehicle 200 might be any of: a truck, a bus, a piece of construction equipment, or a personal vehicle.

The herein disclosed embodiments can thus be applied in heavy-duty vehicles, such as trucks, buses and construction equipment as well as person vehicles. The herein disclosed embodiments are applicable on working machines within the fields of industrial construction machines or construction equipment, such as wheel loaders, articulated haulers, excavators and backhoe loaders. However, the herein disclosed embodiments are not restricted to any particular type of hydrogen vehicle.

It is to be understood that the present invention is not limited to the embodiments described above and illustrated in the drawings; rather, the skilled person will recognize that many changes and modifications may be made within the scope of the appended claims.

1. An energy storage pressure vessel for a hydrogen vehicle, the energy storage pressure vessel comprising:
a pressure vessel for containing hydrogen gas for fuel cells of the hydrogen vehicle, the pressure vessel being radially surrounded by a membrane defining an outer perimeter of the pressure vessel; and
an energy storage system, the energy storage system being provided in the membrane and comprising layers, wherein all layers are provided in a structural electrolyte matrix in the membrane.

2. The energy storage pressure vessel according to claim 1, wherein the energy storage system is a structural battery.

3. The energy storage pressure vessel according to claim 2, wherein the structural battery comprises carbon fibre fiber electrodes that act both as electrodes and as main structural element of the membrane.

4. The energy storage pressure vessel according to claim 3, wherein the membrane comprises alternating layers of negative electrodes, separators, and positive electrodes.

5. The energy storage pressure vessel according to claim 4, wherein a structural battery electrolyte is dispersed throughout the alternating layers.

6. The energy storage pressure vessel according to claim 1, wherein the pressure vessel is cylindrically shaped.

7. The energy storage pressure vessel according to claim 6, wherein the membrane is formed by concentric layers of carbon fibre fiber electrodes that are wrapped around the pressure vessel.

8. The energy storage pressure vessel according to claim 2, wherein the structural battery is composed of a single battery cell.

9. The energy storage pressure vessel according to claim 2, wherein the structural battery is composed of at least two serially connected or parallel connected battery cells.

10. A hydrogen vehicle, the hydrogen vehicle comprising at least one energy storage pressure vessel according to claim 1.

11. The hydrogen vehicle according to claim 10, wherein the hydrogen vehicle further comprises an electric traction motor, and wherein the at least one energy storage system is configured to provide the electric traction motor with electricity for driving the hydrogen vehicle.

12. The hydrogen vehicle according to claim 10, wherein the hydrogen vehicle further comprises a cabin for housing a human driver of the hydrogen vehicle, the cabin comprising electronic components, and wherein the at least one energy storage system is configured to provide the electronic components with electricity.

13. The hydrogen vehicle according to claim 10, wherein the hydrogen vehicle comprises at least two energy storage pressure vessels, and wherein the at least two energy storage pressure vessels are vertically stacked in the hydrogen vehicle.

14. The hydrogen vehicle according to claim 10, wherein the hydrogen vehicle further comprises a cabin for housing a human driver of the hydrogen vehicle, and wherein the at least one energy storage system is in the hydrogen vehicle placed behind the cabin.

15. The hydrogen vehicle according to claim 10, wherein the hydrogen vehicle further comprises at least one further pressure vessel for containing hydrogen gas for fuel cells of the hydrogen vehicle, wherein each at least one further pressure vessel is radially surrounded by a membrane being without any energy storage system.

16. The hydrogen vehicle according to claim 10, wherein the hydrogen vehicle is any of: a truck, a bus, a piece of construction equipment, a personal vehicle.
